(19) United States
(12) Patent Application Publication
(10) Pub. No.: US 2008/0192269 A1
(43) Pub. Date: Aug. 14, 2008

(54) GAMUT MAPPING FOR PRINTER COLOR RENDERING

(75) Inventor: CHING-WEI CHANG, VANCOUVER, WA (US)

Correspondence Address: Stolowitz Ford Cowger LLP/Sharp, 621 SW Morrison St, Suite 600, Portland, OR, 97205, US

(73) Assignee: SHARP LABORATORIES OF AMERICA, INC., CAMAS, WA (US)

(21) Appl. No.: 11/674,120

(22) Filed: Feb. 12, 2007

(51) Int. Cl. H04N 1/60

(52) U.S. Cl. 358/1.9; 358/515

(57) ABSTRACT

A system for color gamut mapping includes a control color list for mapping colors between a first color space and a second color space, and also including a processor. The processor is configured to identify a projected color defined in the first color space and map the projected color to a selected color included in the control color list. The selected color is associated with the projected color according to an ocular comparison of the projected color and a printout of the selected color rendered in the second color space.

### TECHNICAL FIELD

The invention relates to rendering a projected image to a printed image using improved color gamut mapping.

### BACKGROUND

Printing in color typically involves rendering an image to a CMY or CMYK color space. The printed color space has a very different color gamut range from a monitor display color space, such as an RGB color space. Whereas CMY images are created by printing cyan, magenta or yellow dots on a printed media, RGB images are created by combining red, green and blue color pixels. The colors in the RGB and CMY or CMYK images are not always completely compatible with one another. For example, monitors may display variations of blue colors that are unprintable on a printed media. Printed images are able to construct variations of greens and cyan that may not be displayed on the monitor. There is not always an exact match between colors mapped from one color space to the next.

In addition, graphic devices such as printers may be configured differently or include variations in toner quality or other characteristics that result in different printed colors when rendered from the same displayed image on a monitor. Certain applications or geographic considerations may also result in differences in user preferences for printed colors.

Color gamut mapping is an important aspect in color reproduction from monitor color to hard copy printer color. Conventional device color rendering is performed by converting a source color as a contone output color. Since most graphic devices cannot reproduce contone colors directly, a subsequent halftone process is performed to complete the color rendering. This type of device color rendering is called indirect.

Direct color rendering is performed by rendering output device printable colors directly. Conventional color gamut mapping systems utilize Euclidean color distance comparison to measure many possible output colors and arrange them in a color palette. The color palette is analyzed to determine an output color that has the shortest color distance from the input color. This may result in a mathematical closest match to the input color, but not one that provides the closest match from a user perspective. In addition, multiple input colors may be matched to the same mathematically closest output color such that the color variation between the input colors is lost.

The present invention addresses these and other problems associated with the prior art.

### BRIEF DESCRIPTION OF THE DRAWINGS

FIG. 1 illustrates an example block diagram of a simplified system for color gamut mapping including a monitor and a printer.

FIG. 2 illustrates an example block diagram of a system for color gamut mapping including a control color list.

FIG. 3 illustrates an example of a test color chart.

FIG. 4 illustrates an example of a conceptual model of an RGB color space known in the art.

FIG. 5 illustrates an example of a conceptual model of a CMY color space.

FIG. 6 illustrates an example of the control color list of FIG. 2.

FIG. 7 illustrates an example method of color gamut mapping.

### SUMMARY OF THE INVENTION

A system for color gamut mapping is herein disclosed as including a control color list for mapping colors between a first color space and a second color space, and also including a processor. The processor is configured to identify a projected color defined in the first color space and map the projected color to a selected color included in the control color list. The selected color is associated with the projected color according to an ocular comparison of the projected color and a printout of the selected color rendered in the second color space.

A method of color gamut mapping is herein disclosed as identifying a control color belonging to a first color space, generating a list of test colors that are variations of the control color, and rendering the test colors into a second color space. The method further includes receiving user input to identify a selected test color and associating the control color with the selected color, where the selected color is included in a color gamut.

The invention will become more readily apparent from the following detailed description of a preferred embodiment of the invention which proceeds with reference to the accompanying drawings.

### DESCRIPTION OF EXAMPLE EMBODIMENTS

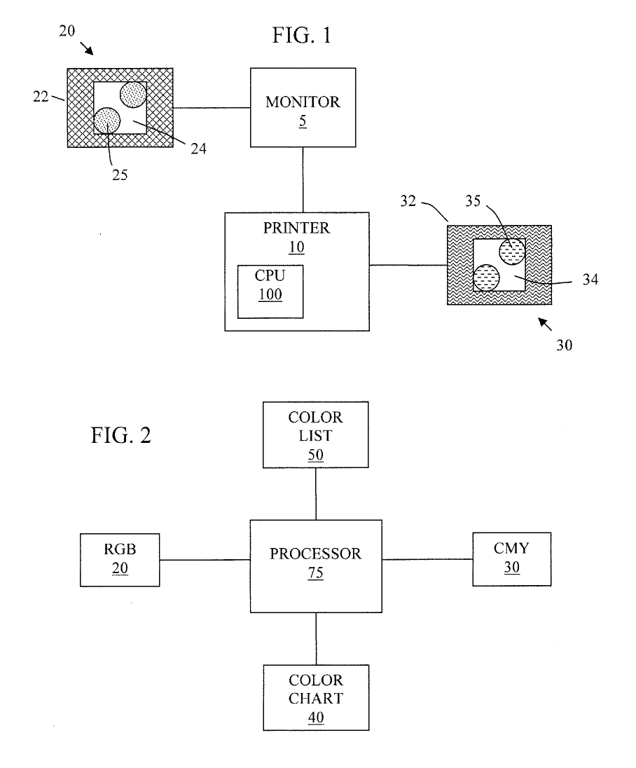

FIG. 1 illustrates an example block diagram of a simplified system for color gamut mapping including a monitor 5 and a printer 10. The monitor 5 may include any conventional display device used to project an image, such as an RGB image 20. The printer 10 may include any graphic device capable of printing an image on a printed media. A printed image such as CMY or CMYK image 30 may be rendered from the RGB image 20 for printing on a printed media by the printer 10. The printer 10 prints the printed image 30 as an approximate likeness of the RGB image 20 as rendered in the CMY color space. The CMY color space may be a printer color space. The printer 10 may include a processor 100 that renders the RGB image 20 into the printed image 30.

The RGB image 20 is shown as including multiple colors. A background color 22 is provided along with a square source image 24 including two circles or dots having a texture color 25. CMY image 30 is also shown as including multiple colors. A background color 32 is provided along with a square image 34 including two circles or dots having a texture color 35. For convenience, the background colors, square images and texture colors will be identified as being either of the RGB of CMY space, for clarity. Any reference to RGB is understood as applying to any color space which may be used to define a monitor or projected image color space. Any reference to CMY is understood as applying to any color space which may be used to define a printed image color space, including the CMYK color space.

In rendering the RGB color image 20 to the CMY color image 30, color gamut mapping may be used to select CMY colors in the CMY color space which match or approximate the RGB colors in the RGB color space. For example, CMY background color 32 may be selected and mapped to RGB background color 22, and CMY texture color 35 may be selected and mapped to RGB texture color 25. Where the RGB square source image 34 is displayed as the color white, this is typically mapped to paper-white in the CMY color space, which indicates an absence of toner.

FIG. 2 illustrates an example block diagram of a system for color gamut mapping including a processor 75 and a control color list 50. The color control list 50 may include or provide an association between RGB colors in the RGB color space with CMY colors in the CMY color space. The color control list 50 may include less than all of the color variations possible in the RGB color space. The processor 75 may be provided in a computer, graphic device, printer or other device including processing capability. In one embodiment, the processor 75 is provided in the printer 10 as processor 100 of FIG. 1.

A color chart 40 may be printed, for example by the printer 10 of FIG. 1, which includes multiple test colors printed in the CMY color space. The color chart 40 may be used to identify which of the test colors is the best color match to an RGB color displayed on a monitor, such as monitor 5 of FIG. 1.

In one embodiment, the system for color gamut mapping shown in FIG. 2 is provided as including a control color list 50 for mapping colors between a first color space, such as the RGB color space, and a second color space, such as the CMY color space. The system further includes a processor, such as processor 75 which may be configured to identify a projected color defined in the first color space. The projected color may include a color shown in RGB image 20, such as RGB texture color 25. The processor 75 may map the projected color 25 to a selected color included in the control color list 50. The selected color may include one of the colors shown in CMY image 30, such as CMY texture color 35. In one embodiment, the projected color 25 is defined in the first color space and may be rendered directly into the second color space as a device printable color. For example, the projected color 25 may combine red and green pixels to display the color yellow, which is rendered as print yellow in the CMY color space, such as selected color 35.

The processor 75 may further be configured to determine a color error between the projected color 25 and the selected color 35; and distribute the color error to neighboring pixels. In one embodiment, the projected color 25 is not included in the list of control colors 50 and does not map directly to a selected color. In that case, the processor 75 may be configured to interpolate an amount of color error. The interpolation may be performed according to a three-dimensional color error diffusion operation. The interpolation may be based on a closest color match to a selected color.

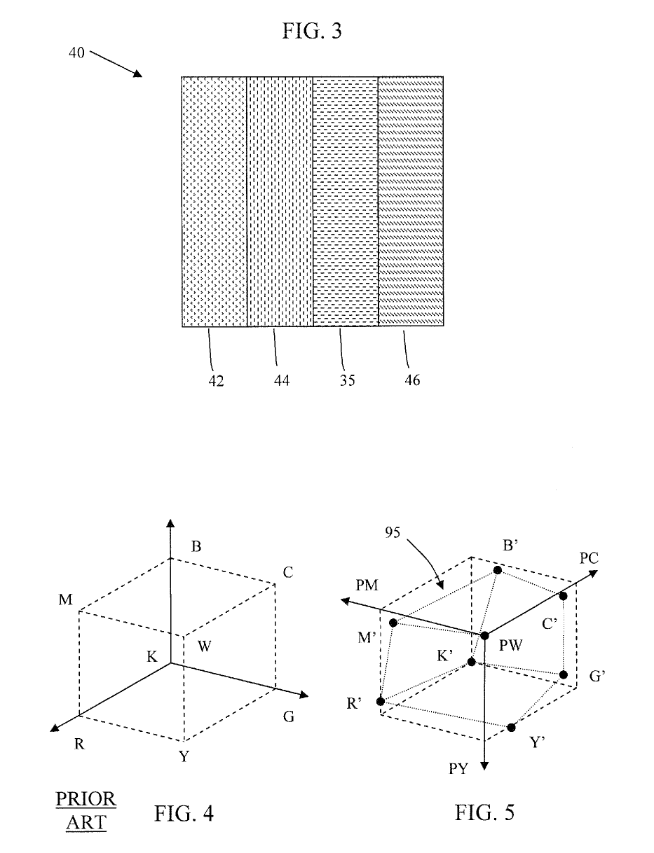

FIG. 3 illustrates an example of a test color chart, such as test color chart 40 of FIG. 2. The test color chart 40 may be printed on a printed media by graphics printer 10 of FIG. 1. The test color chart 40 may include a number of colors that are variations of the projected color 25, which may include a control color. A test color 42 may be a direct rendering of the projected color 25, defined as 100% of the projected color. Using the example where the projected color 25 combines red and green pixels to create a yellow color, the test color 42 may be defined as being 100% printed yellow.

The processor 75 of FIG. 2 may be configured to render the projected color 25 into a rendered color, such as test color 42 that is defined in the second color space. Other test colors that are variations of the projected color 25 may also be rendered and printed on the test color chart 40. By way of illustration, another test color, such as test color 44 may be defined as 100% yellow plus 4% cyan. One of the test colors may include the CMY texture color 35, which may be yet another variation of the projected color 25. For example, texture color 35 may be defined as 100% yellow plus 8% cyan. Yet another test color, such as test color 46, may be defined as 100% yellow plus 12% cyan. More or fewer test colors may be provided on the test color chart 40, including different variations or combinations of the projected color 25, for any of the possible RGB colors provided in the RGB color space. The selected color, such as CMY texture color 35, may therefore be selected from a number of test colors printed out on a test chart, the number of colors being variations of the projected color 25.

In one embodiment, the selected color 35 may be associated with the projected color 25 according to an ocular comparison of the projected color 25 and a printout of the selected color 35 rendered in the second color space. A user may compare the test colors provided in the test color chart 40 with the projected color 25 on the monitor to determine the closest color match according to a visual, ocular comparison. The ocular comparison may take into account such things as personal preference, device characteristics, lighting, printed media characteristics, toner quality, cultural preferences, background colors, etc.

Conventional color gamut mapping systems that use Euclidean color distance comparison may be used to measure the test colors and analyze them to determine an output color that has the shortest color distance from the input color. This may result in a mathematical closest match to the input color, but not one that provides the closest match from a user perspective. For example, based on this mathematical analysis, it may be determined that test color 42 provides the shortest color distance from the projected color 25. However, a user may instead perceive the test color 35 as providing the closest match to the projected color 25, or being the most aesthetically pleasing. Therefore, by using an ocular comparison of the input colors and output colors, test color 35 may be selected for color mapping for the projected color 25, even though it may not provide the shortest color distance.

Two or more RGB input colors that would normally map to the same mathematically closest output color using the Euclidean color distance comparison method, may instead be mapped to two or more different output colors in the CMY color space using the ocular comparison method. Color variation information of the input colors, such as tone and saturation, may be retained in the selected output colors using the improved color gamut mapping.

FIG. 4 illustrates an example of a conceptual model of an RGB color space. The colors red (R), green (G) and blue (B) are indicated by vectors emanating from the origin, identified as black (K). The CMY or CMYK colors may be defined in RGB color space by a color conversion method. The method may include taking into consideration a rendering intent, color profile and black generation. Projected color for cyan (C) may be represented in the RGB color space as RGB color tuple (0,255,255). Projected color for magenta (M) may be represented in the RGB color space as RGB color tuple (255,0,255). Projected color for yellow (Y) may be represented in the RGB color space as RGB color tuple (255,255,0). Projected color for black (B) may be represented in the RGB color space as RGB color tuple (255,255,255). In this manner, a color profile or color tool may not need to be relied on during a color conversion.

FIG. 5 illustrates an example of a conceptual model of a printer CMY color space including a color gamut 95. The printed colors for cyan (PC), magenta (PM) and yellow (PY) are indicated by vectors emanating from the origin, identified as paper-white (PW). Printed colors PC, PM and PY indicate 100% toner used along any of the vectors. Inside the printer CMY space color gamut range, mapped colors for cyan (C′), magenta (M′), yellow (Y′), black (K′), red (R′), green (G′) and blue (B′) are illustrated as corresponding to the monitor colors. The mapped color cyan (C′) may not correspond directly with printed cyan (PC). Similarly, mapped colors for magenta (M′) and yellow (Y′) may not correspond directly to printed magenta (PM) and printed yellow (PY) respectively. Monitor white (W) may be mapped to paper-white (PW). The mapped colors form an irregular cube that encloses the color gamut 95 in the CMY color space.

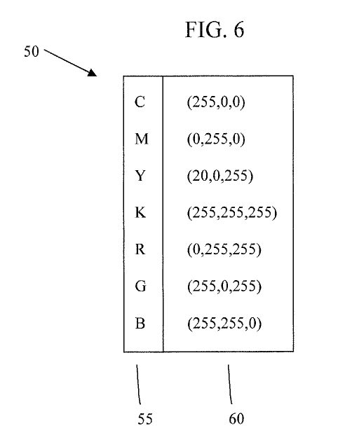

FIG. 6 illustrates an example control color list, such as the color control list 50 of FIG. 2. The color control list 50 includes a list of control colors 55 and a corresponding list of color tuples 60. The control colors 55 are shown as including cyan (C), magenta (M), yellow (Y), black (K), red (R), green (G) and blue (B). These represent the highest saturation colors and neutral colors in a typical color space. More or fewer control colors 55 may be included in the color control list 50. For example 50% red, 50% green, 50% blue and any other variation could be included to provide further color modeling. The list of control colors 55 may be provided as a subset of the possible projected colors 25 in the RGB color space.

The color tuples 60 may be defined in the CMY space. The example color tuples shown include 8-bit representations of the cyan, magenta and yellow color components. An 8-bit representation identified as (255) may indicate 100% color, whereas an 8-bit representation identified as (0) may indicate a 0% color. Taking the control color for red (R) as an example, the color control list 50 indicates a color tuple of (0,255,255). In the CMY color space, this indicates 0% cyan, 100% magenta and 100% yellow. Instead of CMY color tuples, CMYK color representation including four 8-bit color representations could be provided in the color control list. Similarly, other color tuples or color representations for other color spaces could be substituted for the CMY color tuples 60. Conventions other than 8-bit color representations may also be used to describe or define the colors.

According to the previous example, the CMY texture color 35 of FIG. 3 may be selected as the closest color match for the RBG texture color 25, which is identifiable as control color 55 corresponding to monitor yellow (Y). If CMY texture color 35 is defined as 100% yellow plus 8% cyan, this may be represented as a CMY color tuple of (20,0,255), which may be identified as (Y′) in FIG. 5. The number (20) indicates approximately 8% cyan, the number (0) represents 0% magenta, and the number (255) represents 100% yellow. According to the list of color tuples 60 shown in FIG. 6, the color tuple (20,0,255) corresponds with or is mapped to the color yellow (Y) in the RBY color space of FIG. 4. The CMY color tuples 60 may therefore provide a method of converting the control colors 55 identified in the RGB color space into printable colors defined in the CMY color space. Using the above example, a monitor color yellow (Y) may be mapped to print color (Y′)

A control color 55 identified as 100% yellow (Y) in RGB color space, and represented as RGB color tuple (255,255,0) may be mapped using the control color list 50 to a selected color identified as 100% yellow plus 8% cyan (Y′), represented as CMY color tuple (20,0,255), regardless of any mathematical or absolute color distance that my exist between them.

Referring back to the example CMY color space representation shown in FIG. 5, it is noted that the model may be used to map control colors R, G, B, C, M, Y and K in the RGB color space of FIG. 4, to colors R′, G′, B′, C′, M′, Y′ and K′ in the printer CMY color gamut range. Projected colors other than those designated as control colors may be mapped to the color gamut 95 by interpolation.

A three-dimensional color error diffusion method may be used for the interpolation process, however other interpolation techniques or methods may be implemented. An example interpolation method is herein described using the above example which maps the control color 55 identified as 100% yellow (Y) in the RGB color space to the selected color 35 identified as 100% yellow plus 8% cyan (Y′). Assume that an input monitor color defined by the RGB color tuple of (255,240,10) is identified, for example, as the projected color 25, and that the projected color 25 is not provided as one of the control colors 55 in the color control list 50. In this case, the list of CMY color tuples 60 of FIG. 6 may be analyzed to determine which control color has the shortest color distance from the projected color 25.

Methods of determining the best or closest color match known in the art may be used to select the appropriated control color. The control color 55 for yellow (Y) identified by RGB color tuple (255,255,0) may be selected as the closest match to the projected color 25 identified by RGB color tuple (255,240,10). The selected color 35 represented as CMY color tuple (20,0,255) corresponds to the control color 55 of 100% yellow (Y) in the RGB color space according to the control color list 50.

A color error, or color difference between the projected color 25 and the control color 55 may be determined by comparing the 8-bit values for their associated RGB color tuples. Recall that the projected color 25 may be represented as (255,240,10). 100% yellow (Y) may be represented as RGB color tuple (255,255,0). The color difference between the projected color 25 and the control color of 100% yellow (Y), or (255,240,10) and (255,255,0) respectively, is (0,−15,10). The color difference for red (R) is (0). The color difference for (G) is (−15). The color difference for blue (B) is (10). These values may be distributed to the neighboring pixels. The neighboring pixels may be mapped to projected colors modified by the color difference.

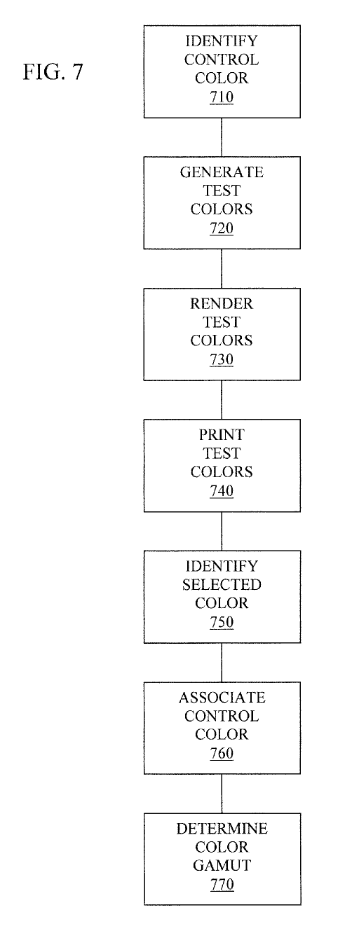

FIG. 7 illustrates an example method of color gamut mapping. At operation 710, a control color 55, which may include a projected color such as RGB texture color 25, is identified. Control color 55 belongs to a first color space, such as the RGB color space.

At operation 720, a list of test colors are generated that are variations of the control color 55. In one embodiment, the test colors include the control color 55 as well as a distributed variation of the control color 55.

At operation 730, the test colors are rendered into a second color space, such as a CMY or CMYK color space. The second color space may be a printer color space.

At operation 740, the rendered test colors are printed out on a test chart, such as color chart 40 of FIG. 3. The color chart may include each of the test colors, such as test colors 42, 44, 35 and 46. The test colors on the printed color chart 40 may be compared to the control color 55 according to an ocular examination by a user, or human observer.

At operation 750, a user input is received to identify a selected test color, such as CMY texture color 35. The selected test color 35 may include a color variation of the rendered control color.

At operation 760, the control color 55 is associated with the selected color 35. The association may be made via a control color list, such as control color list 50 of FIG. 6. The control color list 50 may include selected colors for each control color of red, green, blue, cyan, magenta, yellow and black. Control color list 50 may be included in a table or database, which is accessible to a processor, such as processor 75 of FIG. 2. In one embodiment, processor 75 is configured to perform the operations illustrated in FIG. 7.

At operation 770, a color gamut 95 including the selected color 35 is determined. The color gamut 95 may be defined in part by the CMY color tuples 60 included in the control color list 50.

A color error may be determined between a projected color 25 and the control color 55. The color error may be distributed to neighboring pixels. In one embodiment, the neighboring pixels are mapped to colors modified by the color error.

The amount of color error between the projected color 25 and the control color 55 may be interpolated and applied to non-control colors that do not map directly to a selected color. In one embodiment, the interpolation is performed according to a three-dimensional color error diffusion operation.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. We claim all modifications and variation coming within the spirit and scope of the following claims.

1. A system for color gamut mapping comprising:
a control color list for mapping colors between a first color space and a second color space; and
a processor configured to:
identify a projected color defined in the first color space; and
map the projected color to a selected color included in the control color list, the selected color associated with the projected color according to an ocular comparison of the projected color and a printout of the selected color rendered in the second color space.

2. The system according to claim 1 where the projected color is defined in the first color space and rendered directly into the second color space as a device printable color.

3. The system according to claim 1 where the processor is further configured to:
determine a color error between a non-control color and a control color; and
distribute the color error to neighboring pixels.

4. The system according to claim 1 where the processor is further configured to render the projected color into a rendered color that is defined in the second color space.

5. The system according to claim 4 where the rendered color is selected from a number of colors printed out on a test chart, the number of colors being variations of the projected color.

6. The system according to claim 1 where the projected color does not map directly to a selected color and the processor is configured to interpolate an amount of color error between the projected color and a control color which is mapped directly to a selected color.

7. The system according to claim 6 where the interpolation is performed according to a three-dimensional color error diffusion operation.

8. A method of color gamut mapping comprising:
identifying a control color belonging to a first color space;
generating a list of test colors that are variations of the control color;
rendering the test colors into a second color space;
receiving user input to identify a selected test color; and
associating the control color with the selected color, where the selected color is included in a color gamut.

9. The method according to claim 8 including:
determining a color error between the control color and a projected color; and
distributing the color error to neighboring pixels.

10. The method according to claim 9 including mapping the neighboring pixels to colors modified by the color error.

11. The method according to claim 8 including interpolating an amount of color error to be applied to non-control colors.

12. The method according to claim 8 including associating a selected color for each color of red, green, blue, cyan, magenta and yellow.

13. The method according to claim 8 including printing the rendered test colors in a test chart.

14. The method according to claim 13 where the test colors include the control color.

15. Logic encoded in one or more tangible media for execution and when executed operable to:
identify a control color belonging to a first color space;
generate a list of test colors that are variations of the control color;
render the test colors into a second color space;
identify a selected test color based on ocular visual perception;
associate the control color with the selected color; and
determine a color gamut of the second color space including the selected color.

16. The logic according to claim 15 where the control color is rendered directly into the second color space as a device printable color.

17. The logic according to claim 15 further operable to interpolate an amount of color error between the control color and a projected color where the projected color does not map directly to the selected color.

18. The logic according to claim 15 where the interpolation is performed according to a three-dimensional color error diffusion operation.

19. The logic according to claim 15 further operable to interpolate an amount of color error to be applied to non-control colors.

20. The logic according to claim 15 further operable to associate a selected color for each color of red, green, blue, cyan, magenta and yellow.
